(19) United States
(12) Patent Application Publication
(10) Pub. No.: US 2002/0060375 A1
(43) Pub. Date: May 23, 2002

(54) Cooling tower construction

(76) Inventor: John Albert Davis, King City (CA)

Correspondence Address: Charles W. Fallow, Shoemaker & Mattare, Ltd., Suite 1203, 2001 Jefferson Davis Highway, Arlington, VA, 22202-0286, US

(21) Appl. No.: 10/050,999

(22) Filed: Jan. 22, 2002

Related U.S. Application Data
(63) Continuation-in-part of application No. 09/306,511, filed on May 7, 1999, now abandoned.
(60) Provisional application No. 60/084,978, filed on May 11, 1998.

(51) Int. Cl. B01F 3/04

(52) U.S. Cl. 261/117; 261/DIG. 11

(57) ABSTRACT

A tower for cooling a liquid includes an impermeable outer wall, and a flexible but non-stretchable, porous, air-permeable inner wall spaced inwardly from the outer wall to define a chamber between the two walls. The air-permeable inner wall has a multiplicity of pores through which air can pass in order to remove deposits from the internal face of the inner wall. A delivery means is provided for injecting air into the chamber between the two walls, and further delivery means injects air into the internal volume within the inner wall, this being the cooling air. A further means sprays the liquid into the internal volume surrounded by the inner wall. To provide pressurized air to the annular chamber, openings are provided in the outer wall, and a plenum external to the outer wall communicates with the openings, so that by continuously injecting air into the plenum, it will automatically and continuously pass to the annular chamber, and thence through the pores of the inner wall, in order to clean the inner wall of deposits.

### CROSS-REFERENCE TO RELATED APPLICATIONS

This application claims the benefit of Provisional Application Ser. No. 60/084,978, filed May 11, 1998.

This is a continuation-in-part of U.S. patent application Ser. No. 09/306,511, filed on May 7, 1999, in the name of John Albert Davis.

### FIELD OF THE INVENTION

This invention relates generally to cooling towers, and has to do particularly with an improved construction for cooling towers.

### BACKGROUND OF THIS INVENTION

The processes for directly cooling liquids are among the oldest and simplest known to man. These processes all involve the exposure of the liquid surface to air in varying degrees depending on the nature of the liquid. Some of these cooling processes are slow, such as the cooling of water on the surface of a pond; others are comparatively fast, such as the spraying of water into air.

In industry, it is important that the cooling process be as efficient as possible. In the past, several styles of cooling systems have evolved which are distinguished by the manner in which the air and the liquid are intermingled. Simple spray ponds, wind driven atmospheric cooling systems, natural draft or hyperbolic towers and mechanical draft towers all have found application for the cooling of industrial liquids.

### THE PRIOR ART

The present development concerns the standard tower type of cooling arrangement known in the art, which employs either natural draft, forced draft or induced draft air transfer principles to move air through a confined space in order to force intimate contact with the liquid.

Further, the conventional tower design also employs a mechanical means for increasing the surface area of the liquid; either by spreading the liquid over a large surface area in the case of a “packed” design, or by breaking the liquid up into droplet form in the case of a sprayed tower design. In addition, the towers can be either horizontal (“cross flow”) or vertical in design, with either induced flow or forced draft in the case of the mechanical draft towers.

In all cases the particular tower design relies on the intimate contact of air and liquid. The most efficient way to accomplish this is to present as large a liquid surface as possible to the air. In this way both the latent and the sensible heat transfer mechanisms can be maximized for any given tower design. As a result, several problems arise which affect both the cooling efficiency and the serviceability of any given tower design. These problems may be summarized as follows:

1. Wall wetting: In a typical sprayed tower design a portion of the liquid introduced into the tower will eventually end up wetting the tower wall surface. Water attached to the wall exposes less surface area to the air than does the equivalent mass of water divided up into fine droplets.

2. Build-up: During the latent heat transfer process, a portion of the water within the liquid is evaporated. In liquids containing impurities, build-up occurs on the tower walls and components as the impurities precipitate out of the mixture.

3. Poor Cooling Efficiencies: Inefficient air flow patterns through the cooling tower space result in recirculating air flow patterns, poor contact with the liquid surfaces and poor cooling efficiencies. This problem is especially critical when the site climatic conditions are such that there is little “driving force” between the temperature and humidity of the cooling air and the temperature of the liquid.

Example Problem

The electrowinning of zinc from an electrolyte solution containing zinc ions and sulfuric acid produces unwanted heat which raises the temperature of the electrolyte. In order to reduce the electrolyte temperature, some process operations employ forced draft cooling towers.

In certain instances, these towers are rectangular boxes which have large volumes of air forced in at the bottom and discharged from the open top. The electrolyte is sprayed into the tower from the top to provide a countercurrent in which cooling air flows upward against the downward falling electrolyte droplets. Mist eliminators are mounted above the sprays to reduce the amount of acid carryover out of the tower.

During the operation of these cooling towers, impurities precipitate out onto the walls, the floor and the mist eliminator section of the cooling tower. It is therefore common to have an extra cooling tower added to the cooling circuit so that one tower can be out of service at any time to allow for cleaning.

Non uniform air flows within the tower tend to overload sections of the mist eliminator device and cause excessive carryover of the liquid which increases product loss while emitting contaminants into the surrounding environment.

Also, the traditional cooling tower design described above has serious limitations when used in climates having extended periods of high temperature and/or humidity. In more temperate climates, the towers tend to be over-designed to compensate for the poor cooling performance resulting from inefficient air flow, poor liquid distribution mainly due to the wetting of the tower walls, and impurity build-up.

### GENERAL DESCRIPTION OF THIS INVENTION

This invention includes several elements which combine together to improve the cooling efficiency, the operating characteristics and the maintenance requirements of the standard cooling tower design. In a preferred embodiment of the invention, the following features are noteworthy:

a) The cross-section of the tower is circular. With a circular tower, less wall surface is exposed to the liquid spray pattern. In a conventional rectangular cooling tower, the spray pattern is such that all the spray nozzles direct liquid to the wall surface. However, in the cylindrical tower design of the present invention, it is possible to concentrate the sprays into the center of the cross-section and dramatically reduce spray impingement on the walls of the tower.

b) The sprays and spray header assemblies are all mounted above the demister section and walkways are provided to allow servicing of the sprays from the outside of the tower.

c) A unique support beam is incorporated into the tower constructions which:

i) supports the mist eliminator section;

ii) allows simple removal and replacement of the mist eliminator section;

iii) supports a safety walkway when the mist eliminator section is removed;

iv) has a special pocket molded into a configuration that supports the spray headers. This pocket allows for removal of the spray headers from outside of the tower;

v) has an “O” ring seal on the inside of the pocket that ensures that liquid is not leaked from the tower;

vi) employs a secondary support above the mist eliminator section which allows a removable walkway to provide access to the spray headers.

d) Provision is made for a second saturating spray of fresh water to prevent build-up within the mist eliminator sections. This spray system is also mounted below the mist eliminator sections but is directed concurrent with the air flow to ensure saturation of the air entering the mist eliminator sections.

e) A dynamic inner wall of flexible but essentially non-stretchable, air permeable, porous cloth material is, in a first embodiment, supported at a substantially uniform spacing (a few inches) from the external tower wall, held taut between the underside of the mist eliminator section and the top of the collection sump at the bottom of the tower. This layer of material in effect forms, with the external tower wall, a porous bag of uniform width which is sealed at the top and bottom, around the air inlet to the tower, and around the access door. In a second embodiment, the dynamic inner wall defines an intermediate “waist” or “hourglass” portion, where the diameter is reduced. More specifically, the inner wall can be shaped to resemble two approximately frusto-conical portions with their small ends in contact, which means that the chamber defined between the external and internal walls is not of uniform radial thickness.

An external fan and distribution plenum is used to supply air into the space between the inner wall and the outer vertical support wall of the tower. The air thus distributed then escapes under relatively high velocity through the pores in the bag material. This feature then:

i) re-entrains liquid attached to the “wall” back into the main cooling air which “blows” the liquid off of the internal surface of the bag (inner wall) and increases the surface area of the liquid which in a normal cooling tower would stay attached to the wall.

ii) provides additional cooling air to the system, as the atomizing air is taken from outside the cooling tower.

iii) allows for pulsing (either automatic or simple manual on/off) of the air supply which then provides a self cleaning action to remove any build-up on the inner surface of the material.

f) This tower design also incorporates a built-in overflow, sump and weir assembly which reduces the overall footprint of the tower, saving valuable real estate and greatly reducing the installation costs over conventional designs.

A number of unique features of this invention make the device clearly distinguishable from other devices currently in use, namely:

1. a round housing to provide more uniformity to the air flow intermingling with the falling liquid droplets and to ensure a more uniform velocity through the mist eliminator sections;

2. an innovative support structure to ease construction of the tower as well as provide safe access to the mist eliminator sections, spray headers and distribution piping;

3. a saturating spray of fresh water to eliminate the wet/dry zone within the eliminators and reduce build-up;

4. a dynamic wall system that reintroduces back into the cooling air stream the liquid flows that would normally attach themselves to the wall;

5. a self-contained weir system to collect and guide the liquid to the collector pipe.

More particularly, this invention provides a cooling tower for a liquid, comprising:

a liquid-impermeable outer wall,

a flexible but substantially non-stretchable, air-permeable inner wall disposed within the outer wall and spaced inwardly away therefrom, whereby a chamber is defined between the outer and inner walls, and whereby a generally elongate internal volume is defined by and enclosed by the said inner wall,

said inner wall having a multiplicity of pores through which air can pass from said chamber to said elongate internal volume,

air injector means by which air can be continuously injected into the said chamber, and from there pass continuously through said pores into said internal volume,

air moving means by which air can be introduced into said internal volume and induced to travel therealong, and

spraying means for spraying said liquid into said internal volume in a pattern which is such as to substantially restrain the liquid from impingement against said inner wall.

Furthermore, this invention provides a method of cooling a liquid, utilizing:

a cooling tower which comprises:

a liquid-impermeable outer wall, a flexible but substantially non-stretchable, air-permeable inner wall disposed within the outer wall and spaced inwardly away therefrom, whereby a chamber is defined between the outer and inner walls, and whereby a generally elongate internal volume is defined by and enclosed by the said inner wall, said inner wall having a multiplicity of pores through which air can pass to said elongate internal volume, air injector means by which air can be continuously injected into the said chamber, and from there pass continuously through said pores into said internal volume, air moving means by which air can be injected into said internal volume and induced to travel therealong, and spraying means for spraying said liquid into said internal volume in a pattern which is such as to substantially restrain the liquid from impingement against said inner wall, the method including the simultaneous steps:

a) using said air injector means to inject air continuously into said chamber, so that it passes through said pores;

b) using said air moving means to inject air into one end of the internal volume so that it travels therealong; and

c) using said spraying means to spray the said liquid into the internal volume while substantially avoiding impingement against said inner wall.

### GENERAL DESCRIPTION OF THE DRAWINGS

Two embodiments of this invention are illustrated in the accompanying drawings, in which like numerals denote like parts throughout the several views, and in which:

FIG. 1 is an elevational view of a cooling tower constructed in accordance with the first embodiment of this invention;

FIG. 2 is a plan view of the cooling tower of FIG. 1;

FIG. 3 is a sectional view taken at the line D-D in FIG. 1;

FIG. 4 is an elevational view of the cooling tower of FIG. 1, taken along a direction perpendicular to the direction for FIG. 1;

FIG. 5 is a sectional view taken at the line A-A in FIG. 1;

FIG. 6 is a sectional view taken at the line B-B in FIG. 1;

FIG. 7 is a sectional view taken at the line C-C in FIG. 1, and also shows schematically where the line C-C crosses the inflated bag 36 in the second embodiment of this invention;

FIG. 8 is a schematic detail of a dynamic wall anchor for the top and bottom around the air inlet and the access door opening, according to the structure surrounded by an ellipse 8 in FIG. 4; and

FIG. 9 is a simplified elevational view of a second embodiment of a cooling tower constructed in accordance with this invention.

### DETAILED DESCRIPTION OF THE DRAWINGS

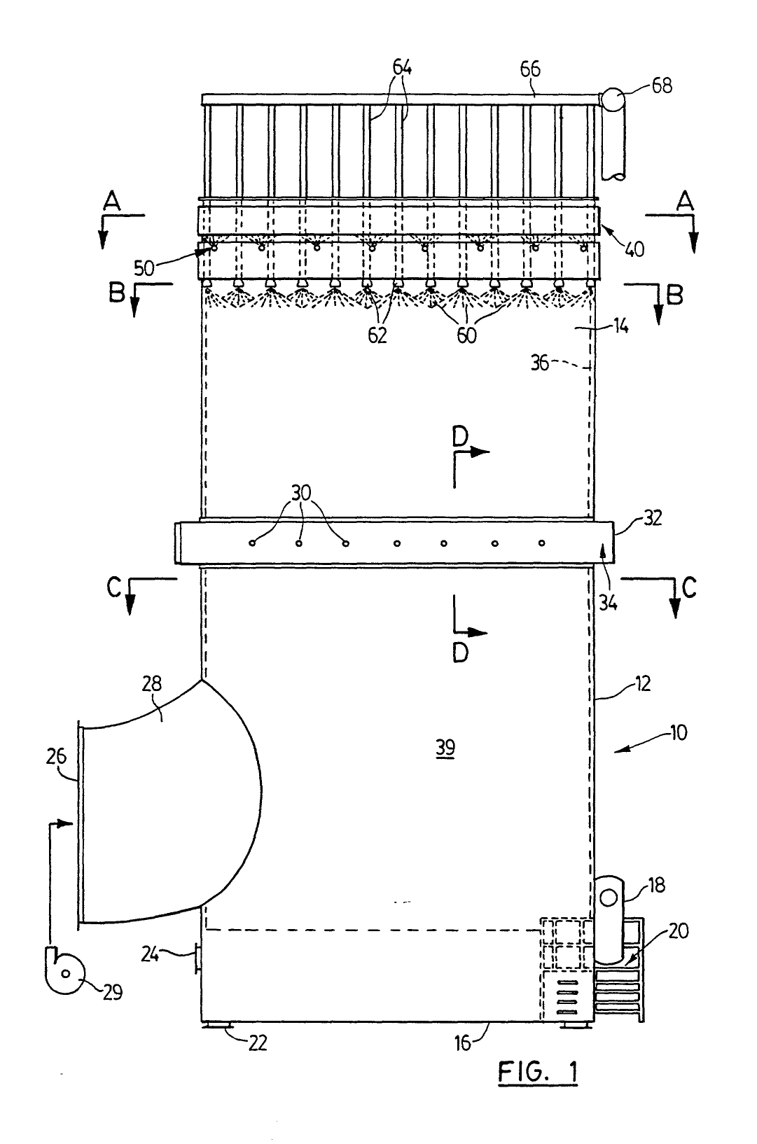

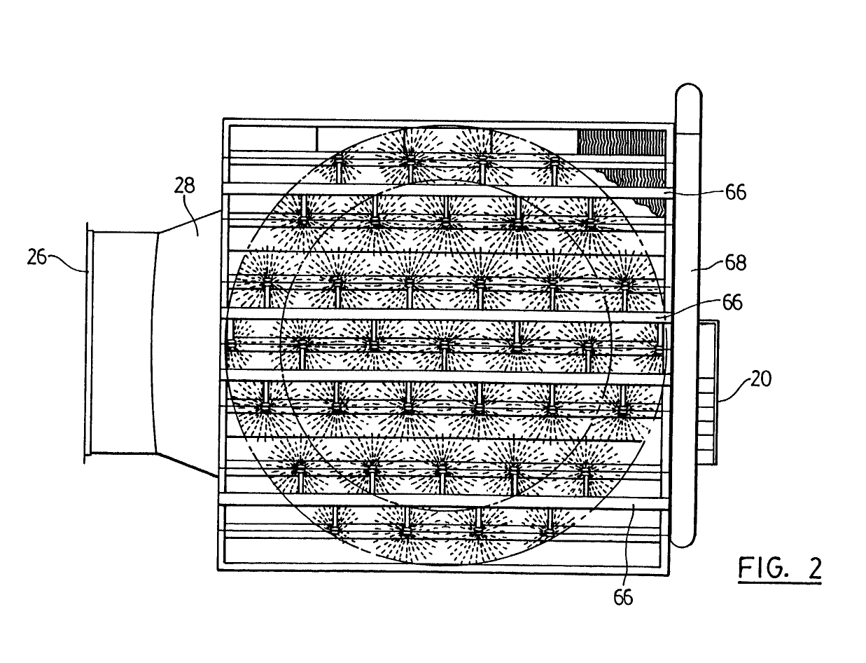

Attention is first directed to FIG. 1, which shows a cooling tower 10 which has a cylindrical outer wall 12 with an open upper end 14 and a closed lower end 16. At lower right in FIG. 1 there is shown an access door 18 and a set of steps 20 leading to the door 18, allowing maintenance personnel to enter the interior of the cooling tower 10. At lower left in FIG. 1 there is provided a drain outlet 22, along with a hinged view port 24.

A circular air access opening 26 is connected to the interior of the cooling tower 10 along a curvilinear conduit 28, and receives air from an air mover shown schematically at 29.

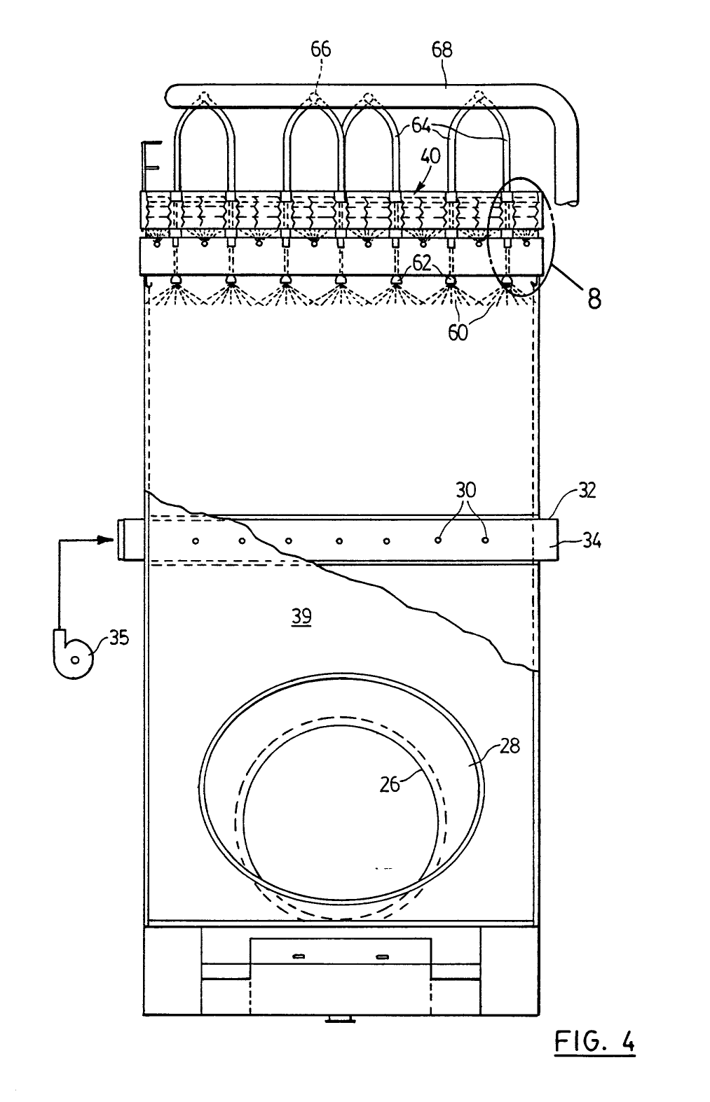

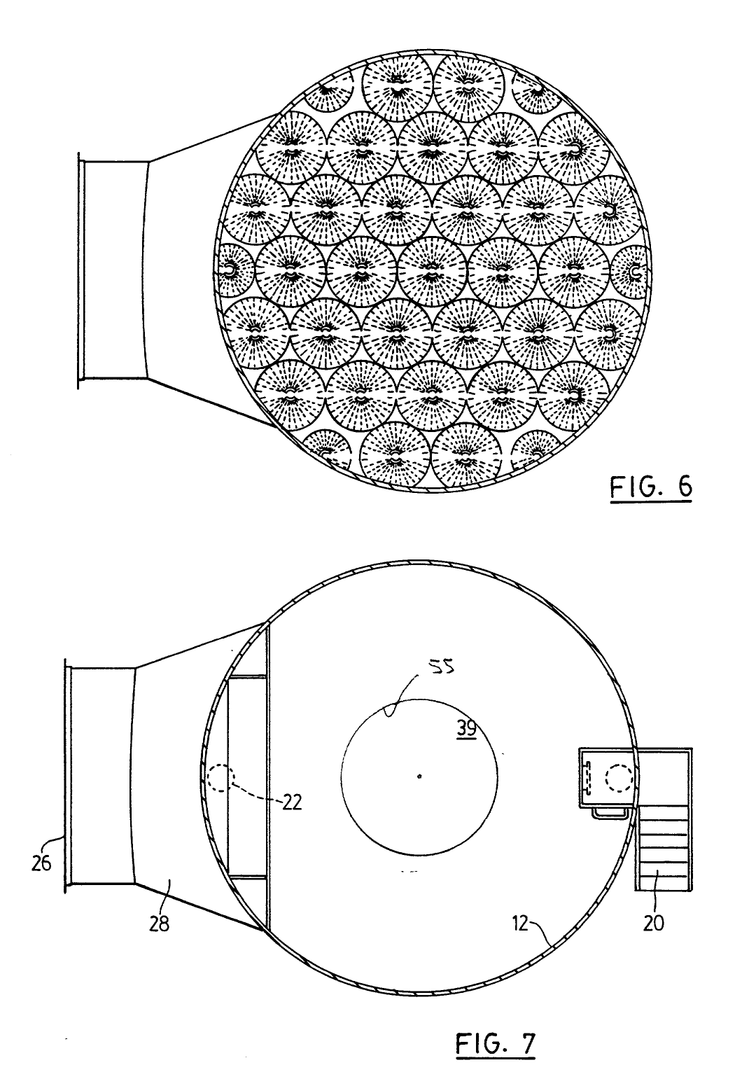

Somewhat above the vertical mid-point of the cooling tower 10 are provided a plurality of openings 30, generally equally spaced around the wall 12, and generally located in the same horizontal plane. Enclosing the openings 30 is a peripheral shell member 32 which defines an annular cavity 34, the latter being connected to air-injecting means, shown schematically at 35 in FIG. 4. (The openings 30 would not normally be visible through the shell member 32, but are included for illustrative purposes.)

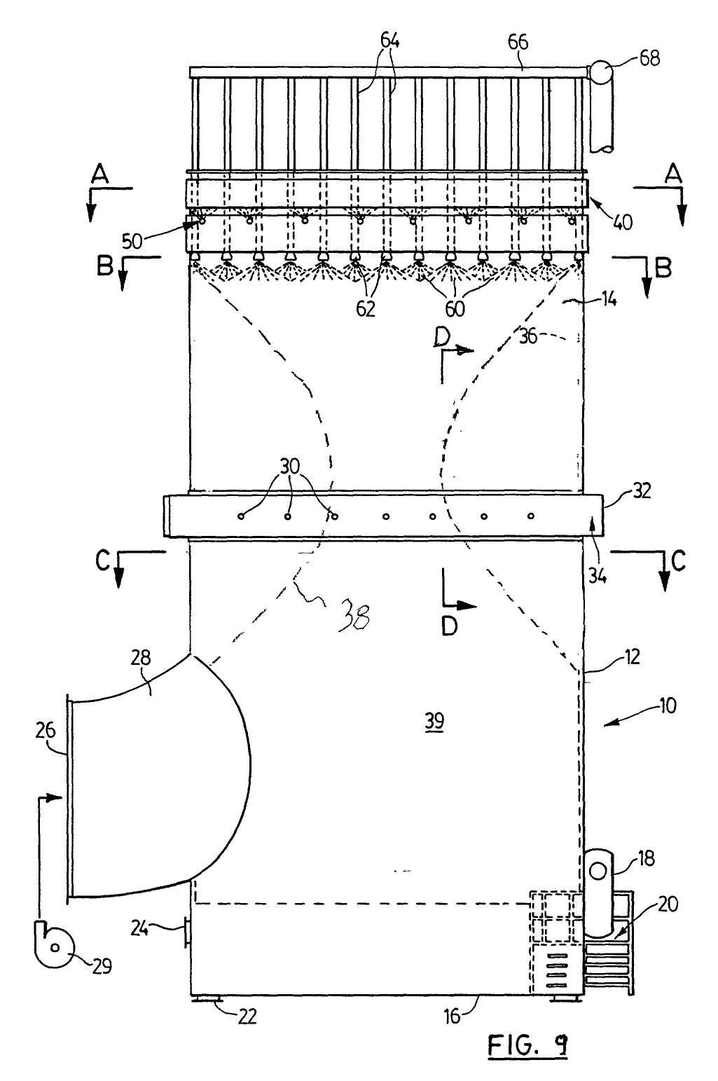

Suspended inside and adjacent to the wall 12, but spaced inward therefrom, is a dynamic inner wall 36 of flexible, non-stretchable, air-permeable material, such as porous cloth. The wall 36 is supported under tension between the underside of the mist eliminator section (described below) and the top of the collection sump at the bottom 16 of the tower 10 (and around the access door 18), and, in a first embodiment, defines with the outer wall 12 an annular chamber 37 of substantially uniform radial width (a few inches). The inner wall 36 defines and encloses an elongate internal volume 39 (which is also enclosed by the outer wall 12). Note that, in accordance with a second embodiment shown in FIG. 9, the inner wall 36a has a “waist” portion 38 at an intermediate location, which causes the chamber defined between the inner and outer walls to have a varying radial dimension. In FIG. 9, the inner wall is seen to resemble two conical frustums, placed with their small ends together.

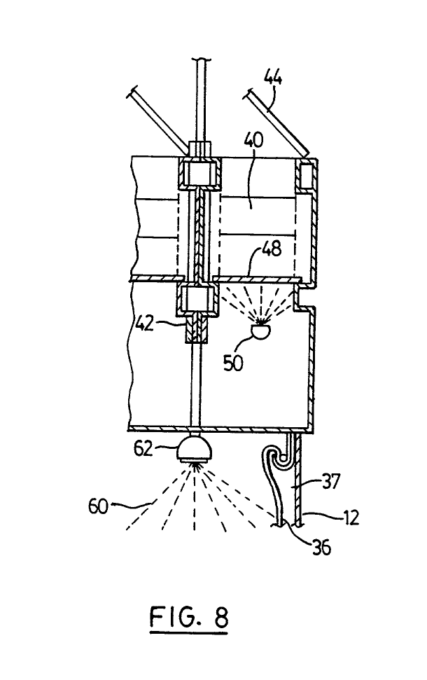

Looking now at the upper portion of the cooling tower shown in FIG. 8, a mist eliminator section 40 is supported by a support beam 42 which allows simple removal and replacement of the mist eliminator section, and which supports a safety walkway 44 when the mist eliminator sections are removed. The support beam 42 has a special pocket molded into a configuration that supports the spray pipe, the pocket allowing for removal of the spray headers from outside the tower. An “O” ring seal inside the pocket (not illustrated) ensures that liquid is not leaked from the tower. Also, the support beam 42 employs a secondary support above the mist eliminator section which allows access to the spray heads without removing the mist eliminator section. Provision is made at 50 for a second saturating spray of fresh water to prevent build-up within the mist eliminator section. This spray system is mounted below the mist eliminator section, but is directed in the same direction as the air flow, thereby ensuring saturation of the air entering the mist eliminator section. Removable panels 48 allow access to the spray heads at 50.

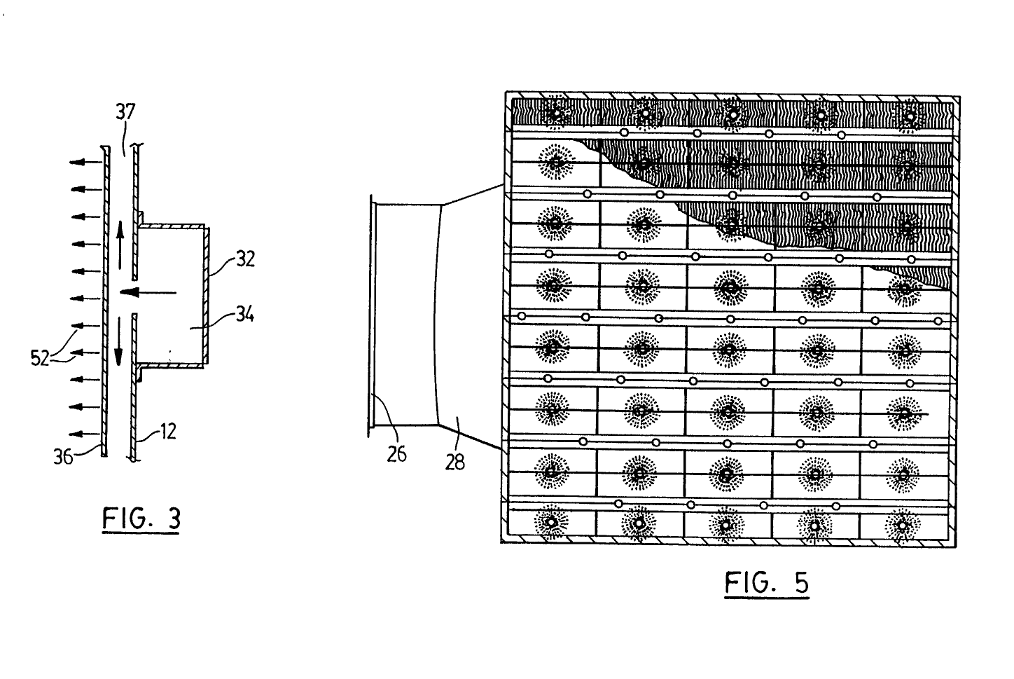

An external fan and distribution manifold (not illustrated) is used to supply air to the space between the bag and the external vertical support wall of the tower. As seen at 52 in FIG. 3, the air thus distributed is allowed to escape under relatively high velocity through the pores in the bag material 36. This feature re-entrains liquid attached to the “wall” back into the main cooling air flow. The multitude of high velocity jets “blows” the liquid off the surface of the bag and increases the surface area of the liquid which in a normal cooling tower would remain adhered to the wall. This feature further provides additional cooling air to the system, because the atomizing air is taken from outside the cooling tower. Further, this feature allows for pulsing (automatic or manual) of the air supply, which produces a self-cleaning action to counteract any build-up on the surface of the material.

It has been explained above that an optional configuration for the inner wall is one which includes a “waisted” region, as seen at 38 in FIG. 9. It can be advantageous to structure the inner wall such that the majority (or all) of the pores are located in the region where the diameter is smallest (i.e. the “waist”). For example, the least diameter of the flexible liner may lie between 250 mm and 1000 mm. This maximizes the “jet effect” of the exhaust, which shears the liquid off the wall of the flexible liner.

In FIG. 7, the circle 55 shows where the waisted region 38 of the inner wall is crossed by the sectional line C-C in FIG. 9.

As seen in FIG. 8, the electrolyte (i.e., the main liquid to be cooled) is sprayed downwardly at 60 from a plurality of nozzles 62 which are connected to vertical feed pipes 64 connected at their upper ends to headers 66 which are in turn connected to a main conduit 68.

While one embodiment of this invention has been illustrated in the accompanying drawings and described hereinabove, it will be evident to those skilled in the art that changes and modifications may be made thereto, without departing from the essence of this invention, as set forth in the appended claims.

The embodiments of the invention in which an exclusive property or privilege is claimed are defined as follows:

1. A cooling tower for a liquid, comprising:
a liquid-impermeable outer wall,
a flexible but substantially non-stretchable, air-permeable inner wall disposed within the outer wall and spaced inwardly away therefrom, whereby a chamber is defined between the outer and inner walls, and whereby a generally elongate internal volume is defined by and enclosed by the said inner wall,
said inner wall having a multiplicity of pores through which air can pass from said chamber to said elongate internal volume,
air injector means by which air can be continuously injected into the said chamber, and from there pass continuously through said pores into said internal volume,
air moving means by which air can be introduced into said internal volume and induced to travel therealong, and
spraying means for spraying said liquid into said internal volume in a pattern which is such as to substantially restrain the liquid from impingement against said inner wall.

2. The cooling tower claimed in claim 1, in which said outer and inner walls are both substantially cylindrical and have a substantially vertical common axis, whereby said chamber is substantially annular, and whereby there is defined an upper end and a lower end of the tower, and in which said air moving means includes air-blowing means for blowing air continuously into said internal volume adjacent the lower end of the tower, the tower including, adjacent the upper end, aperture means by which the blown air can escape from said internal volume.

3. The cooling tower claimed in claim 1, in which said air injector means comprises:
opening means through said outer wall,
means defining a cavity external to the outer wall and communicating with said opening means,
and air-injecting means for injecting air into the cavity, thence into the chamber, thence through the pores and into said internal volume.

4. The cooling tower claimed in claim 2, in which said air injector means comprises:
a plurality of aligned openings in said outer wall, the openings being uniformly distributed around the periphery of the outer wall,
a shell member secured externally to said outer wall and defining therewith a cavity communicating with said plurality of openings,
and air-injecting means for injecting air into the cavity, thence into the annular chamber, thence through the pores and into said internal volume.

5. The cooling tower claimed in claim 2, further comprising a support beam located above the spraying means, a mist eliminator section above the support beam, and a safety walkway above the mist eliminator section.

6. The cooling tower claimed in claim 5, further comprising, below the mist eliminator section, a spray means for fresh water, to prevent build-up within the mist eliminator section; the spray direction from the spray means being opposite to that from said spraying means.

7. The cooling tower claimed in claim 1, in which the outer wall is substantially cylindrical and the inner wall has the shape of an hourglass, and in which said air moving means includes air-blowing means for blowing air continuously into said internal volume adjacent the lower end of the tower, the tower including, adjacent the upper end, aperture means by which the blown air can escape from said internal volume.

8. The cooling tower claimed in claim 7, in which said air injector means comprises:
a plurality of aligned openings in said outer wall, the openings being uniformly distributed around the periphery of the outer wall,
a shell member secured externally to said outer wall and defining therewith a cavity communicating with said plurality of openings,
and air-injecting means for injecting air into the cavity, thence into the chamber, thence through the pores and into said internal volume.

9. The cooling tower claimed in claim 7, further comprising a support beam located above the spraying means, a mist eliminator section above the support beam, and a safety walkway above the mist eliminator section.

10. The cooling tower claimed in claim 9, further comprising, below the mist eliminator section, a spray means for fresh water, to prevent build-up within the mist eliminator section; the spray direction from the spray means being opposite to that from said spraying means.

11. A method of cooling a liquid, utilizing:
a cooling tower which comprises:
a liquid-impermeable outer wall, a flexible but substantially non-stretchable, air-permeable inner wall disposed within the outer wall and spaced inwardly away therefrom, whereby a chamber is defined between the outer and inner walls, and whereby a generally elongate internal volume is defined by and enclosed by the said inner wall, said inner wall having a multiplicity of pores through which air can pass to said elongate internal volume, air injector means by which air can be continuously injected into the said chamber, and from there pass continuously through said pores into said internal volume, air moving means by which air can be injected into said internal volume and induced to travel therealong, and spraying means for spraying said liquid into said internal volume in a pattern which is such as to substantially restrain the liquid from impingement against said inner wall, the method including simultaneously:
a) using said air injector means to inject air continuously into said chamber, so that it passes through said pores;
b) using said air moving means to inject air into one end of the internal volume so that it travels therealong; and
c) using said spraying means to spray the said liquid into the internal volume while substantially avoiding impingement against said inner wall.

12. The method claimed in claim 11, in which said outer and inner walls are both substantially cylindrical and have a substantially vertical common axis, whereby said chamber is substantially annular, and whereby there is defined an upper end and a lower end of the tower, and in which said air moving means includes air-blowing means for blowing air into said internal volume adjacent the lower end of the tower, the tower including, adjacent the upper end, aperture means by which the blown air can escape from said internal volume.

13. The method claimed in claim 11, in which the outer wall is substantially cylindrical and the inner wall has the shape of an hourglass, the inner and outer walls having a substantially vertical common axis, whereby the chamber is substantially annular, and whereby there is defined an upper end and a lower end of the tower, and in which said air moving means includes air-blowing means for blowing air into said internal volume adjacent the lower end of the tower, the tower including, adjacent the upper end, aperture means by which the blown air can escape from said internal volume.
